(19) United States
(12) Patent Application Publication
(10) Pub. No.: US 2026/0196389 A1
(43) Pub. Date: Jul. 9, 2026

(54) CHIP RESISTOR

(71) Applicant: KOA CORPORATION, Ina-shi, Nagano (JP)

(72) Inventors: Taro KIMURA, Ina-shi (JP); Keita KAWAKAMI, Ina-shi (JP)

(73) Assignee: KOA CORPORATION, Ina-shi, Nagano (JP)

(21) Appl. No.: 18/865,232

(22) PCT Filed: Feb. 9, 2023
(86) PCT No.: PCT/JP2023/004355

§ 371 Date: Nov. 12, 2024

(30) Foreign Application Priority Data
May 11, 2022 (JP) 2022-078175

(51) Int. Cl. H01C 7/18; H01C 1/01; H01C 1/148; H01C 17/28

(52) U.S. Cl. CPC H01C 7/18; H01C 1/01; H01C 1/148; H01C 17/281

(57) ABSTRACT

A chip resistor includes an insulating substrate, a pair of front electrodes, a pair of back electrodes, a resistor, a second insulating layer covering the resistor, a third insulating layer layered on the second insulating layer, a pair of auxiliary electrode layers made of a resin material containing conductive particles and layered on the front electrodes, a pair of end face electrodes to electrically connect between the auxiliary electrode layers and the back electrodes corresponding thereto, and a pair of external plating layers provided to cover the auxiliary electrode layers and surfaces of the end face electrodes, wherein the auxiliary electrode layers covering surfaces of ends of the third insulating layer, and the second insulating layer contains more inorganic filler than the third insulating layer.

### TECHNICAL FIELD

The present invention relates to a chip resistor for surface-mount.

### BACKGROUND ART

A typical chip resistor mainly includes a rectangular parallelepiped insulating substrate, a pair of front electrodes that is provided on a front surface of the insulating substrate to face each other with a predetermined distance therebetween, a resistor that bridges between the pair of front electrodes, an insulating protective film that covers the resistor, a pair of back electrodes that is provided on a back surface of the insulating substrate to face each other with a predetermined distance therebetween, a pair of end face electrodes that electrically connects the front electrodes and the back electrodes, and a pair of external plating layers that covers each of the electrodes described above.

In this typical chip resistor, the front electrodes are made of an Ag (silver) based metal material having low resistivity, and the external plating layers are formed so as to cover the front electrodes. In this structure, strongly corrosive sulfide gas or the like easily enters a gap which corresponds to a boundary portion between the external plating layer and the protective film. This may cause a portion of the front electrode at a boundary position between the front electrode and the protective film to be corroded by the sulfide gas, and such corrosion may cause the problems such as the change in a resistance value and the disconnection.

As disclosed in Patent Literature 1, for improving the resistance to sulfurization, a conventionally proposed chip resistor has a structure in which a protective electrode made of a synthetic resin having conductivity is formed to be connected to both a front electrode and a protective film, an end face electrode is formed on the front electrode and the protective electrode so as not to be in contact with the protective film, and an external plating layer is formed to cover an end portion of the protective film beyond a boundary portion between the protective electrode and the end face electrode.

### CITATION LIST

### Patent Literature

Patent Literature 1: WO2018/123419

### SUMMARY OF INVENTION

### Technical Problem

In the chip resistor disclosed in Patent Literature 1, the protective film made of an insulating resin material covers the resistor and the protective electrode is formed so as to be in contact with the upper surface of the end portion of the protective film, so that the protective electrode and the protective film are brought into close contact with each other. However, a resin material commonly used for the protective film contains an inorganic filler such as SiO₂ in order to provide the heat resistance and the mechanical strength against heat generated in the resistor, while a resin material commonly used for the protective electrode contains metal particles in order to provide the conductivity, and accordingly, the adhesion between the protective electrode and the protective film is hindered by the inorganic filler and the metal particles. This may cause the risk that a gap is formed at the boundary surface between the protective electrode and the protective film due to the thermal stress generated due to the heat cycle or the like, and thus a sulfide gas or the like enters from the gap.

The present invention has been made in view of the circumstances of the prior art described above, and an object thereof is to provide a chip resistor with excellent corrosion resistance.

### Solution to Problem

In order to achieve the object described above, the present invention provides a chip resistor comprising: a rectangular parallelepiped insulating substrate; a pair of front electrodes provided at both ends of a main surface of the insulating substrate; a resistor with both ends overlapping the pair of front electrodes; a protective film made of a resin material, which is provided so as to cover the resistor; an auxiliary film made of a resin material, which is layered on the protective film; a pair of auxiliary electrode layers made of a resin material containing conductive particles, which is layered on the electrodes; a pair of end face electrodes extending at least to both end faces of the insulating substrate to electrically connect to the auxiliary electrode layers; and external plating layers covering the auxiliary electrode layers and the end face electrodes, wherein the auxiliary electrode layers are formed to extend to positions covering surfaces of ends of the auxiliary film, and the protective film contains more inorganic filler than the auxiliary film.

In the chip resistor having the structure described above, the auxiliary electrode layers made of a resin material containing conductive particles are layered on the front electrodes, and also the auxiliary electrode layers are in contact with the upper surfaces of the ends of the auxiliary film layered on the protective film. The protective film contains more inorganic filler than the auxiliary film, which increases the content of resin in the auxiliary film relatively and thus enables enhancement in the adhesion between the auxiliary electrode layers and the auxiliary film. Accordingly, even if the thermal stress is generated due to the heat cycle or the like, peeling off of the auxiliary electrode layers from the auxiliary film, which may be caused by the thermal stress, can be suppressed, and thus the sulfide gas hardly enters the inside from boundary surfaces between the auxiliary electrode layers and the auxiliary film. This enables the prevention of corrosion of the front electrodes due to sulfide gas.

In the chip resistor having the structure described above, in the case of providing the resistor with a trimming groove for adjustment of a resistance value, a glass layer for covering the whole of the resistor, including connection portions between the front electrodes and the resistor, is preferably provided, and the protective film is preferably layered on the glass layer.

Furthermore, in the chip resistor having the structure described above, inorganic filler contained in the resin material of the auxiliary film is preferably less than that contained in the protective film, and in particular, making the content of the inorganic filler in the resin material of the auxiliary film zero or less than or equal to 10 wt % increases the ratio of the resin in the auxiliary film significantly, and thus enables efficient improvement in the adhesion between the auxiliary electrode layers and the auxiliary film.

Furthermore, in the chip resistor having the structure described above, the resin material of the protective film and that of the auxiliary film may be different, however, forming the protective film and the auxiliary film with the similar kind of materials enables further improvement in the adhesion between the auxiliary electrode layers and the auxiliary film.

Furthermore, in the chip resistor having the structure described above, where a length along a short-side direction of the insulating substrate is defined as a width dimension, setting a width dimension of each of the auxiliary electrode layers to be more than a width dimension of each of the front electrodes and also less than a width dimension of the auxiliary film causes each of the auxiliary electrode layers, on which a plating material is easily to be formed, to be arranged in an area of the insulating substrate which is inner than the end face in the long-side direction, and thus the plating material is formed on the end face of the insulating substrate in its long-side direction with the same film thickness as the other portions. A local increase in the film thickness may cause the external plating layers to be peeled off, however, it can be prevented in this structure.

Furthermore, in the chip resistor having the structure described above, the auxiliary film does not necessarily have to cover the whole upper surface of the protective film, however, setting an outer shape of the auxiliary film more than an outer shape of the protective film so that the auxiliary film is formed to cover the whole surface of the protective film can preferably improve the adhesion between the auxiliary electrode layers and the auxiliary film.

### Advantageous Effects of Invention

According to the present invention, a chip resistor capable of exhibiting the excellent corrosion resistance by preventing an auxiliary electrode layer from being peeled off.

### BRIEF DESCRIPTION OF DRAWINGS

FIG. 1 is a top view of a chip resistor according to an embodiment of the present invention.

FIG. 2 is a cross-sectional view taken along line II-II of FIG. 1.

FIG. 3 is a top view illustrating producing processes of the chip resistor.

FIG. 4 is a top view illustrating producing processes of the chip resistor.

FIG. 5 is a cross-sectional view illustrating producing processes of the chip resistor.

FIG. 6 is a cross-sectional view illustrating producing processes of the chip resistor.

FIG. 7 illustrates a flowchart of producing processes of the chip resistor.

FIG. 8 is a cross-sectional view illustrating the chip resistor as mounted.

### DESCRIPTION OF EMBODIMENTS

Hereinafter, an embodiment of the present invention will be described with reference to the drawings.

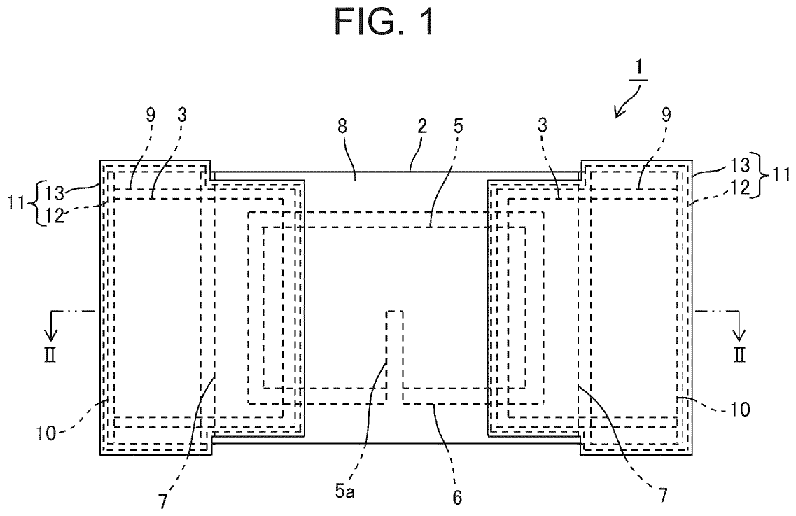

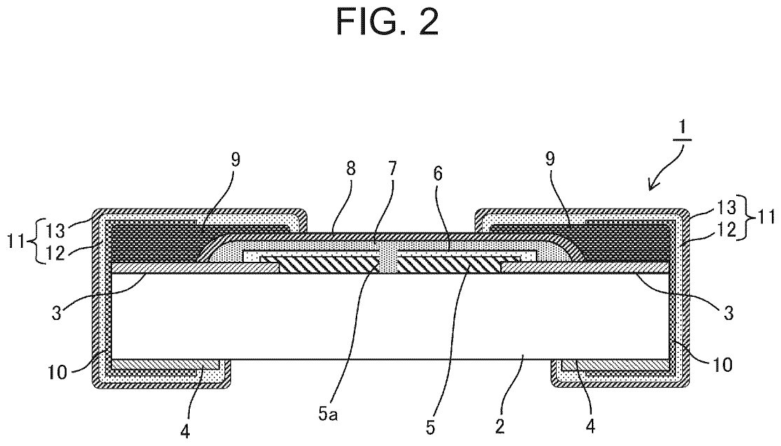

FIG. 1 is a cross-sectional view of a chip resistor according to an embodiment of the present invention, and FIG. 2 is a cross-sectional view taken along line II-II of FIG. 1.

As illustrated in FIG. 1 and FIG. 2, a chip resistor 1 according to the present embodiment mainly includes a rectangular parallelepiped insulating substrate 2, a pair of front electrodes 3 formed on the upper surface of the insulating substrate 2 at both the ends in the longitudinal direction thereof, a pair of back electrodes 4 formed on the lower surface of the insulating substrate 2 at both the ends in the longitudinal direction thereof, a rectangular-shaped resistor 5 with both the ends overlapping the pair of front electrodes 3, a first insulating layer (glass layer) 6 covering the whole of the resistor 5 including connection portions between the front electrodes 3 and the resistor 5, a second insulating layer (protective film) 7 layered on the first insulating layer 6, a third insulating layer (auxiliary film) 8 layered on the second insulating layer 7, a pair of auxiliary electrode layers 9 layered on the front electrodes 3, a pair of end face electrodes 10 extending both the end faces of the insulating substrate 2 to electrically connect between the front electrodes 3 (and the auxiliary electrode layers 9) and the back electrodes 4, and a pair of external plating layers 11 provided to cover the auxiliary electrode layers 9 and the top surfaces of the end face electrodes 10.

The insulating substrate 2 is made of ceramics or the like. A sheet-shaped and large-sized substrate, which will be described later, is divided along a primary division groove and a secondary division groove extending vertically and the horizontally, respectively, so that a plurality of insulating substrates 2 can be obtained.

The pair of front electrodes 3 is obtained by screen-printing an Ag-based paste containing Pd and drying sintering the printed paste. The pair of the front electrodes 3 is formed on the upper surface of the insulating substrate 2 at both the ends in the longitudinal direction thereof, each of which has a rectangular shape when viewed from above. Where the short-side direction of the insulating substrate 2 (vertical direction in FIG. 1) is defined as the width direction, both the ends of the front electrode 3 in the width direction are not in contact with the long sides of the insulating substrate 2, and thus the dimension in the width direction of each of the front electrodes 3 is less than the dimension in the width direction of the insulating substrate 2.

The pair of back electrodes 4 is obtained by screen-printing an Ag-based paste and drying sintering the printed paste. The pair of back electrodes 4 is formed on the lower surface of the insulating substrate 2 at both the ends in the longitudinal direction thereof, each of which has a rectangular shape when viewed from above. The dimension in the width direction of each of the back electrodes 4 is also less than the dimension in the width direction of the insulating substrate 2.

The resistor 5 is obtained by screen-printing a resistive paste such as ruthenium oxide and drying and sintering the printed paste. Both the ends of the resistor 5 in its longitudinal direction overlap the front electrodes 3. The resistor 5 is provided with a trimming groove 5a for adjustment of a resistance value.

The first insulating layer 6 is obtained by screen-printing a glass paste and drying and sintering the printed paste. The first insulating layer 6 is formed so as to cover the whole of the resistor 5 before being provided with the trimming groove 5a.

The second insulating layer 7 is obtained by screen-printing a resin paste such as epoxy resin or phenol resin and heating and curing the printed paste. The second insulating layer 7 is formed so as to cover the whole of the first insulating layer 6 after being provided with the trimming groove 5a, and both the ends of the second insulating layer 7 in its width direction are in contact with the long sides of the insulating substrate 2. A resin material of the second insulating layer 7 contains an inorganic filler such as SiO₂ and Al₂O₃ to provide the heat resistance and the mechanical strength. The higher content of the inorganic filler in the resin material of the second insulating layer 7 is preferable, and in the present embodiment, the content of the inorganic filler is set to be in the range of 20 wt % to 40 wt %, however, it may be 40 wt % or more.

The third insulating layer 8 is obtained by screen-printing a resin paste such as epoxy resin or phenol resin and heating and curing the printed paste. The third insulating layer 8 is formed so as to cover the whole of the second insulating layer 7, and both the ends of the third insulating layer 8 in its width direction are also in contact with the long side of the insulating substrate 2. That is, the dimension of the third insulating layer 8 in its longitudinal direction is set to be more than that of the second insulating layer 7 in its longitudinal direction, and the thus third insulating layer 8 covers the whole of the upper surface of the second insulating layer 7, including the connection portions with the front electrodes 3. The resin material of the third insulating layer 8 contains an inorganic filler with the content being less than that of the second insulating layer 7, or does not contain any inorganic filler (content=0%). The content of the inorganic filler contained in the resin material of the third insulating layer 8 is preferably in the range of less than 10 wt %, and in the present embodiment, more preferably, it is set to be 5 wt % or less.

The third insulating layer 8 does not necessarily have to cover the whole upper surface of the second insulating layer 7, but may be formed on the upper surface of the second insulating layer 7 excluding the connection portions with the front electrodes 3. In this case, although the third insulating layer 8 does not come into contact with the front electrodes 3 so that portions of the second insulating layer 7 are exposed from between both the ends of the third insulating layer 8 and the front electrodes, the auxiliary electrode layers 9 can cover and adhere to both the ends of the third insulating layer 8.

The auxiliary electrode layers 9 are obtained by screen-printing a resin paste, such as epoxy resin or phenol resin, with which conductive particles such as Ag, Cu, or Ni are filled, and heating and curing the printed paste. Each of the auxiliary electrode layers 9 is formed in a range covering the upper surface of the front electrode 3 and extending to the middle of the upper surface of the third insulating layer 8, so that the curved portions of both the ends of the third insulating layer 8 can be covered with the auxiliary electrode layers 9. The resin material of the auxiliary electrode layers 9 and that of the third insulating layer 8 may be different from each other, however, the third insulating layer 8 and the third insulating layer 8 are preferably formed of the similar kind of resin materials. The auxiliary electrode layers 9 do not necessarily have to cover the whole upper surfaces of the surface electrodes 3. In this case, the auxiliary electrode layers 9 may be formed at inner positions away from the end faces of the insulating substrate 2 so that portions of the front electrodes 3 are exposed from between the end faces of the insulating substrate 2 and the auxiliary electrode layers 9.

Here, a coefficient of the thermal expansion of the third insulating layer 8 sandwiched between the second insulating layer 7 and the auxiliary electrode layers 9 is preferably a value between a coefficient of the thermal expansion of the second insulating layer 7 and that of the auxiliary electrode layers 9. In the present embodiment, the relation of the coefficients of the thermal expansion among them is set to the second insulating layer 7>the third insulating layer 8>the auxiliary electrode layers 9, however, it may be the auxiliary electrode layers 9>the third insulating layer 8>the second insulating layer 7. Furthermore, as for the glass transition temperatures among the second insulating layer 7, the third insulating layer 8, and the auxiliary electrode layers 9, the glass transition temperature of the second insulating layer 7 and that of the auxiliary electrode layers 9 are preferably included in the range of ±10% of the glass transition temperature of the third insulating layer 8.

The end face electrodes 10 are obtained by depositing Ni-Cr or the like by sputtering. The end face electrodes 10 electrically connect the front electrodes 3 and the auxiliary electrode layers 9, and the back electrodes 4, which are separated in the vertical direction via the end faces of the insulating substrate 2. In this structure, the upper surfaces of the auxiliary electrode layers 9 which are closer to the third insulating layer 8 are not covered with the end surface electrodes 10, and also, inner portions of the back electrode 4 which are away from the end faces of the insulating substrate 2 are not covered with the end surface electrodes 10.

Each of the external plating layers 11 has a double layer structure composed of a barrier layer 12 provided on the inner layer side and an external connection layer 13 provided on the outer layer side. The barrier layer 12 is an Ni-plating layer formed by electroplating, and covers the whole surface of the end face electrode 10, a portion of the auxiliary electrode layer 9 which is exposed from the end face electrode 10, and the back electrode 4. The external connection layer 13 is an Sn-plating layer formed by electroplating, and covers the whole surface of the barrier layer 12.

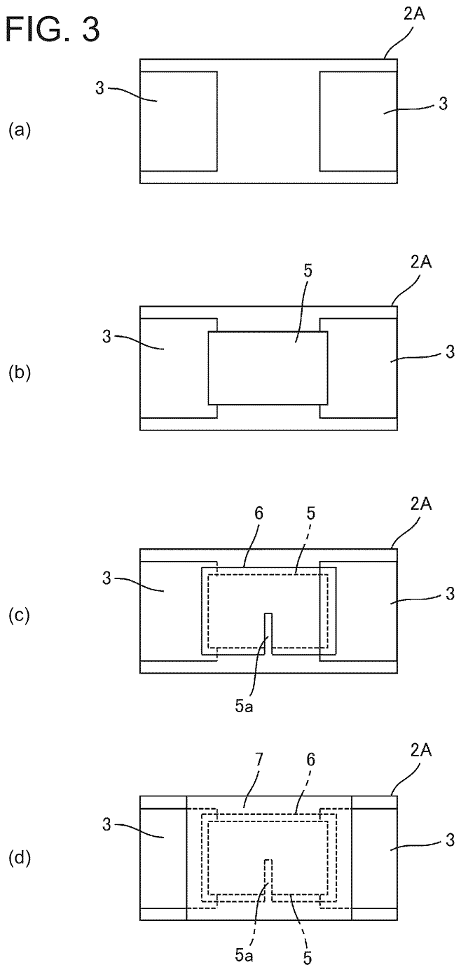

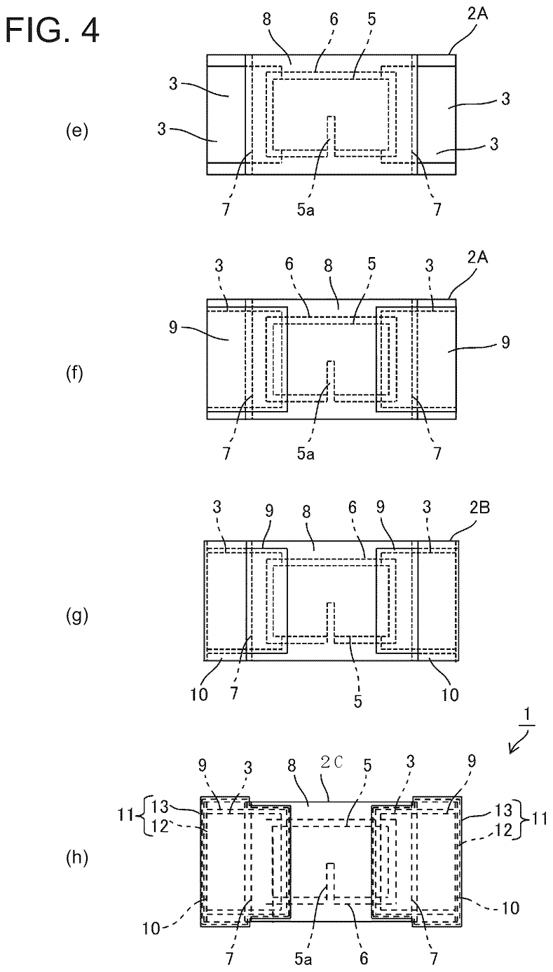

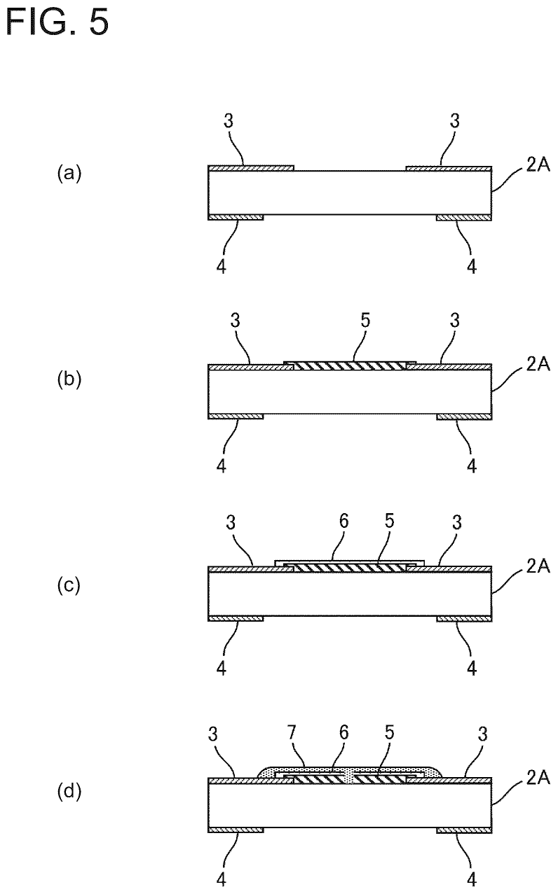

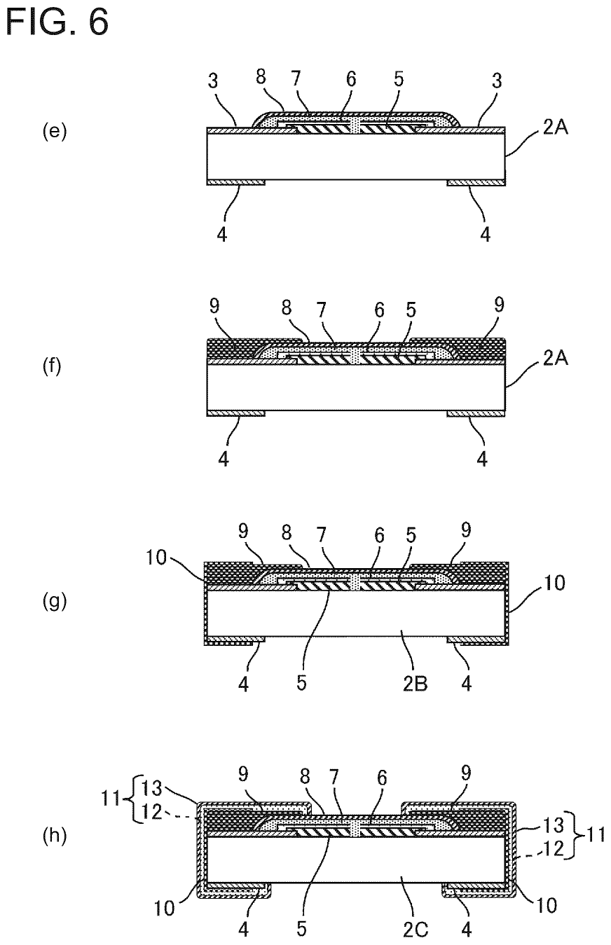

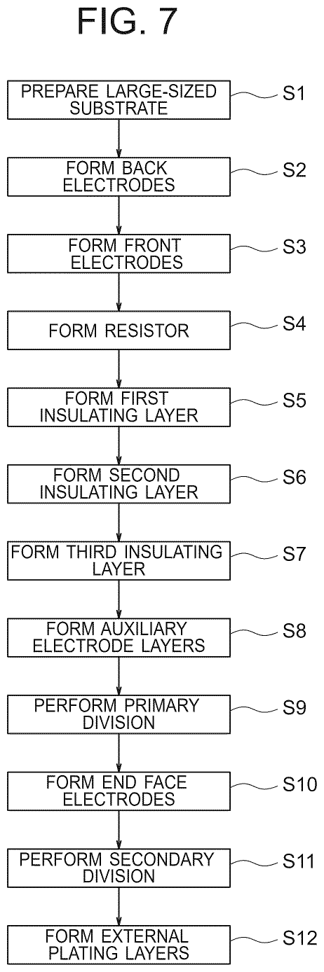

Next, a method of producing the chip resistor 1 having the structure as described above will be explained with reference to FIG. 3 and FIG. 7. Each of FIG. 3 and FIG. 4 is a top view illustrating the producing processes of the chip resistor 1, each of FIG. 5 and FIG. 6 is a cross-sectional view illustrating the producing processes of the chip resistor 1, and FIG. 7 illustrates a flowchart of the producing processes of the chip resistor 1.

Firstly, as illustrated in step S1 of FIG. 7, a sheet-shaped and large-sized substrate 2A, from which the plurality of insulating substrates 2 is obtained, is prepared. The large-sized substrate 2A is provided with the primary division groove and the secondary division groove which extend to form a grid. Each of the areas separated by the primary and secondary division grooves serves as one chip forming region. Each of FIG. 3 to FIG. 6 illustrates one chip forming region as a representative example, however, in actual cases, a plurality of chip forming regions as illustrated therein is arranged to form a grid pattern.

After an Ag paste is screen-printed on the back surface of the large-sized substrate 2A, the printed paste is dried and then sintered at 850° C., thereby forming the pair of back electrodes 4 facing each other with a predetermined distance therebetween at both the ends in the longitudinal direction of each of the chip forming regions (step S2 of FIG. 7). Next, after an Ag—Pd paste is screen-printed on the front surface of the large-sized substrate 2A, the printed paste is dried and then sintered at 850° C., thereby, as illustrated in FIG. 3(a) and FIG. 5(a), forming the pair of front electrodes 3 facing each other with a predetermined distance therebetween at both the ends in the longitudinal direction of each of the chip forming regions (step S3 of FIG. 7). Note that the order of forming the front electrodes 3 and the back electrodes 4 may be reversed, or the front electrodes 3 and the back electrodes 4 may be formed simultaneously.

Next, after a resistive paste containing ruthenium oxide or the like is screen-printed on the front surface of the large-sized substrate 2A, the printed paste is dried and then sintered at 850° C., thereby, as illustrated in FIG. 3(b) and FIG. 5(b), forming the rectangular resistor 5 with both the ends overlap the front electrodes 3 (step S4 of FIG. 7).

Next, after a glass paste is screen-printed in the area covering the resistor 5, the printed paste is dried and then sintered at 600° C., thereby, as illustrated in FIG. 3(c) and FIG. 5(c), forming the first insulating layer 6, which covers the whole of the resistor 5 and also the connection end portions with the front electrodes 3 (step S5 of FIG. 7). Then, the first insulating layer 6 is irradiated with a laser light from above to form the trimming groove 5a so as to adjust a resistance value.

Next, after an epoxy resin-based (or phenolic resin-based) paste is screen-printed on the first insulating layer 6, the printed paste is heated and cured (baked) at 200° C., thereby, as illustrated in FIG. 3(d) and FIG. 5(d), forming the second insulating layer 7 covering the whole of the first insulating layer 6 (step S6 of FIG. 7). In order to provide the heat resistance and the mechanical strength, a resin material of the second insulating layer 7 contains 20 wt % to 40 wt % of an inorganic filler such as SiO₂ and Al₂O₃.

Next, after an epoxy resin-based (or phenolic resin-based) paste is screen-printed on the second insulating layer 7, the printed paste is heated and cured at 200° C., thereby, as illustrated in FIG. 4(e) and FIG. 6(e), forming the third insulating layer 8 covering the whole of the second insulating layer 7 (step S7 of FIG. 7). The resin material of the third insulating layer 8 contains an inorganic filler with the content being less than that of the second insulating layer 7, or does not contain any inorganic filler, and the content of the inorganic filler contained in the third insulating layer 8 is 10 wt % or less (including 0).

Next, after a resin paste, such as epoxy resin or phenol resin, with which conductive particles (Ag base, Cu base, Ni base, etc.) are filled is screen-printed, the printed paste is heated and cured at 200° C., thereby, as illustrated in FIG. 4(f) and FIG. 6(f), forming the auxiliary electrode layers 9 on the pair of front electrodes 3, respectively (step S8 of FIG. 7). The auxiliary electrode layers 9 are formed in a range covering the upper surfaces of the front electrodes 3 and extending to the middle of the upper surface of the third insulating layer 8, so that the curved portions of both the ends of the third insulating layer 8 are covered with the auxiliary electrode layers 9.

The processes described so far are collectively performed with respect to the large-sized substrate 2A. In the subsequent processes, as illustrated in step S9 of FIG. 7, the large-sized substrate 2A is primarily broken (primary-division) along the primary division groove to obtain a strip-shaped substrate 2B. Thereafter, Ni/Cr is deposited by sputtering toward the divided faces of the strip-shaped substrate 2B, thereby, as illustrated in FIG. 4(g) and FIG. 6(g), forming the pair of end face electrodes 10 that electrically connects the front electrodes 3 and the auxiliary electrode layers 9, and the back electrodes 4 (step S10 of FIG. 7). In this process, each of the end face electrodes 10 is formed to have a U-shaped cross section so as to cover the auxiliary electrode layer 9 and the surface of the back electrode 4 which is closer to its outer end, however, the upper surface of the auxiliary electrode layer 9 which is closer to the third insulating layer 8 is not covered with the end face electrode 10, and also the surface of the back electrode 4 which is closer to its inner end is not covered with the end face electrode 10.

Next, as illustrated in step S11 of FIG. 7, the strip-shaped substrate 2B is secondarily broken (secondary-division) along the secondary division groove to obtain a single chip 2C having the same size as that of the chip resistor 1.

Thereafter, Ni-electroplating is applied to the single chip 2C obtained by the division, thereby forming the barrier layers 12 covering the end face electrodes 10. Then, Sn-electroplating is applied to the single chip 2C, thereby forming the external connection layers 13 covering the barrier layers 12. Thus, as illustrated in FIG. 4(h) and FIG. 6(h), the external plating layers 11 each having a double layer structure formed with the barrier layer 12 and external connection layer 13 are formed (step S12 of FIG. 7), whereby the chip resistor 1 as illustrated in FIG. 1 and FIG. 2 can be obtained.

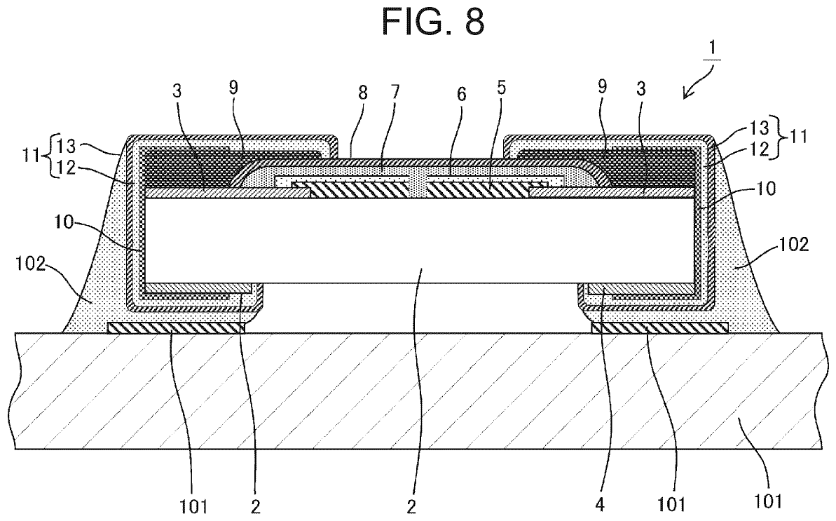

As illustrated in FIG. 8, the chip resistor 1 thus produced is placed on lands 101 of a circuit board 100 with the back surface of the insulating substrate 2 facing downward, and is surface-mounted such that the pair of external plating layers 11 is bounded to the corresponding lands 101 via solders 102, respectively.

As described above, in the chip resistor 1 according to the present embodiment, the auxiliary electrode layers 9 made of a resin material containing conductive particles are layered on the front electrodes 3, and also the auxiliary electrode layers 9 are in contact with the upper surfaces of the ends of the third insulating layer (auxiliary film) 8 layered on the second insulating layer (protective film) 7. The second insulating layer 7 contains more inorganic filler than the third insulating layer 8, which increases the content of resin in the third insulating layer 8 relatively, while the heat resistance and the mechanical strength can be secured by the second insulating layer 7, and thus enables enhancement in the adhesion between the auxiliary electrode layers 9 and the third insulating layer 8. Accordingly, in the chip resistor 1 mounted as illustrated in FIG. 8, even if the thermal stress is generated due to the heat cycle or the like, peeling off of the auxiliary electrode layers 9 from the third insulating layer 8, which may be caused by the thermal stress, can be suppressed, and thus the sulfide gas hardly enters the inside from boundary surfaces between the auxiliary electrode layers 9 and the third insulating layer 8. This enables the prevention of corrosion of the front electrodes 3 due to sulfide gas.

Furthermore, in the chip resistor 1 according to the present embodiment, where the length along the short-side direction of the insulating substrate 2 is defined as the width dimension, the width dimension of each of the auxiliary electrode layers 9 is set to be more than the width dimension of each of the front electrodes 3 and also less than the width dimension of the third insulating layer 8. In this structure, each of the auxiliary electrode layers 9, on which a plating material is easily to be formed, is arranged in an area of the insulating substrate 2 which is inner than the end face in the long-side direction, and thus, in the process of forming the barrier layer 12 and the external connection layer 13 by electroplating, the plating material is formed on the end face of the insulating substrate 2 in its long-side direction with the same film thickness as the other portions. A local increase in the film thickness may cause the external plating layers 11 to be peeled off, however, it can be prevented in this structure.

The present invention is not limited to the embodiment described above, and various modifications can be made without departing from the concept of the present invention. The present invention covers all the technical matters included in the technical ideas described in the scope of claims. The embodiment described above is a suitable example, and those skilled in the art can make various alternative examples, modifications, variations, and the like based on the disclosures herein, and these are included in the technical scope described in the claims.

For example, the first insulating layer (glass layer) 6 may not be provided in a chip resistor that does not require the adjustment of a resistance value of the resistor 5, and in such a case, the resistor 5 may be covered with the two layers of the second insulating layer (protective film) 7 and the third insulating layer (auxiliary film) 8.

Furthermore, in the embodiment described above, the chip resistor 1 includes the back electrodes 4 provided on the back surface of the insulating substrate 2 to be electrically connected to the front electrodes 3 and the auxiliary electrode layers 9, however, the present invention can be applied to a chip resistor without including the back electrodes as described above.

### REFERENCE SIGNS LIST

1 chip resistor
2 insulating substrate
2A large-sized substrate
2B strip-shaped substrate
2C single chip
3 front electrode
4 back electrode
5 resistor
5a trimming groove
6 first insulating layer (glass layer)
7 second insulating layer (protective film)
8 third insulating layer (auxiliary film)
9 auxiliary electrode layer
10 end face electrode
11 external plating layer
12 barrier layer
13 external connection layer

1. A chip resistor comprising:
a rectangular parallelepiped insulating substrate;
a pair of front electrodes provided at both ends of a main surface of the insulating substrate;
a resistor with both ends overlapping the pair of front electrodes;
a protective film made of a resin material, which is provided so as to cover the resistor;
an auxiliary film made of a resin material, which is layered on the protective film;
a pair of auxiliary electrode layers made of a resin material containing conductive particles, which is layered on the front electrodes;
a pair of end face electrodes extending at least to both end faces of the insulating substrate to electrically connect to the auxiliary electrode layers; and
external plating layers covering the auxiliary electrode layers and the end face electrodes, wherein
the auxiliary electrode layers are formed to extend to positions covering surfaces of ends of the auxiliary film, and
the protective film contains more inorganic filler than the auxiliary film.

2. The chip resistor according to claim 1, further comprising a glass layer for covering the whole of the resistor, including connection portions between the front electrodes and the resistor, wherein
the protective film is layered on the glass layer.

3. The chip resistor according to claim 1, wherein
a content of the inorganic filler contained in the resin material of the auxiliary film is zero or less than or equal to 10 wt %.

4. The chip resistor according to claim 1, wherein
the protective film and the auxiliary film are made of a similar kind of resin materials.

5. The chip resistor according to claim 1, wherein
where a length along a short-side direction of the insulating substrate is defined as a width dimension, a width dimension of each of the auxiliary electrode layers is set to be more than a width dimension of each of the front electrodes and also less than a width dimension of the auxiliary film.

6. The chip resistor according to claim 1, wherein
an outer shape of the auxiliary film is set to be more than an outer shape of the protective film, and the auxiliary film is formed so as to cover a whole surface of the protective film.

7. The chip resistor according to claim 1, further comprising back electrodes provided on a back surface of the insulating substrate, wherein
the end surface electrodes are electrically connected to the back electrodes.
